(19) United States
(12) Patent Application Publication
(10) Pub. No.: US 2012/0068829 A1
(43) Pub. Date: Mar. 22, 2012

(54) Anti-collision method and system for reading data from multiple RFID tags

(76) Inventor: Xiaoming Shi, Belle Mead, NJ (US)

(21) Appl. No.: 13/200,121

(22) Filed: Sep. 17, 2011

(30) Foreign Application Priority Data
Sep. 21, 2010 (CN) 201010288581.5

(51) Int. Cl. H04Q 5/22

(52) U.S. Cl. 340/10.2

(57) ABSTRACT

A radio frequency identification (RFID) system for reading data from multiple RFID tags without radio frequency (RF) signal collision. The system includes a RF caller (102) for transmitting a calling message (106) with a tag ID through a calling channel (104), a plurality of RFID tags (108) for receiving the calling message (106) on the calling channel (104), a RFID tag (110) of the RFID tags (108) for responding the calling message (106) to transmit a tag message (114) through a recording channel (112), and a RF recorder (116) for receiving the tag message (114) on the recording channel (112). At any time at most one message is transmitted through one RF channel, which can avoid any RF signal collision.

### CROSS-REFERENCE TO RELATED APPLICATIONS

This application claims the benefit of China Patent Application No. 201010288581.5 filed on Sep. 21, 2010, the disclosure of which is incorporated herein by reference in its entirety.

### FIELD OF THE INVENTION

The invention relates to radio frequency identification (RFID) system for reading data from RFID tag, especially relates to reading data from multiple RFID tags with an anti-collision method.

### BACKGROUND OF THE INVENTION

Currently RFID system consists of RFID reader and RFID tag, RFID reader reads data from RFID tag through transmitting interrogating RF (Radio Frequency) signal and receiving response RF signal from RFID tag. A RFID tag without any power supply is called as a passive RFID tag; A RFID tag with power supply is called as an active RFID tag.

A passive RFID tag consists of electric circuit with processor and connected antenna. The antenna of RFID tag receives RF signal and energy transmitted by a RFID reader, then the electric circuit of RFID tag is activated, and then response message is generated and transmitted through the antenna of RFID tag; RFID reader receives the response message to obtain the data of RFID tag. A passive RFID tag cost is low, but its signal is weak and can only be detected in short distance.

Compare with passive RFID tag, an active RFID tag transmits RF signal with power supply from a battery, its signal is stronger and can be detected in long distance, but its cost is higher and has the issue of battery life.

At present there is always a RF signal collision issue when a RFID reader tries to read data from multiple passive tags or active tags. When multiple RFID tags locate within the interrogation zone of a RFID reader, more than one tags may attempt to transmit RF signals to the RFID reader simultaneously, then the RF signal collision could occur which results in RF signal receiving failure on the RFID reader. Although currently there are some anti-collision algorithms and technical trying to resolve this problem, but none of them can avoid the collision completely. The current solutions can be categorized as the followings:

1. Try to reduce the possibility of collision in some ways.

2. Try to detect the RF signal collision and then retransmit the RF signal if any RF signal collision is detected.

3. Combine 1 and 2.

Instead of getting rid of RF signal collision, current solutions are either to try to reduce the possibility of any RF signal collision or to handle the occurrence of any RF signal collision.

### SUMMARY OF THE INVENTION

In accordance with one embodiment, an anti-collision RFID system is provided, which includes a RF caller for transmitting a calling message with a RFID tag identifier through a calling channel, a plurality of RFID tags for receiving the calling message on calling channel, one of the RFID tags for transmitting a tag message through a recording channel, and a RF recorder for receiving the tag message on the recording channel.

A RFID tag transmits its tag message only when this RFID tag has received a calling message on calling channel and when the tag identifier within the calling message equals to the tag identifier of this RFID tag.

There are two RF channels in the system: calling channel and recording channel. Through each of these two channels, at most one RF signal is transmitted at anytime, so that the whole system can avoid internal RF signal collision completely.

Based on the above basic embodiment, some other embodiments can also be set up.

### BRIEF DESCRIPTION OF THE DRAWINGS

The benefits and advantages of the present invention will become apparent from the subsequent description of the preferred embodiments and the appended claims, taken in conjunction with the accompanying drawings, in which:

FIG. 1A is a block diagram of a first embodiment of an anti-collision RFID system for reading data from multiple RFID tags;

FIG. 1B is an example of an attendance recording system establishment incorporating the system of FIG. 1A;

FIG. 2A is a block diagram of a second embodiment of an anti-collision RFID system the for reading data from multiple RFID tags;

FIG. 2B is an example of an attendance recording system establishment incorporating the system of FIG. 2A;

FIG. 3 is a flow diagram illustrating operation procedures of an anti-collision method and system for reading data from multiple RFID tags.

### DETAILED DESCRIPTION OF THE PREFERRED EMBODIMENT

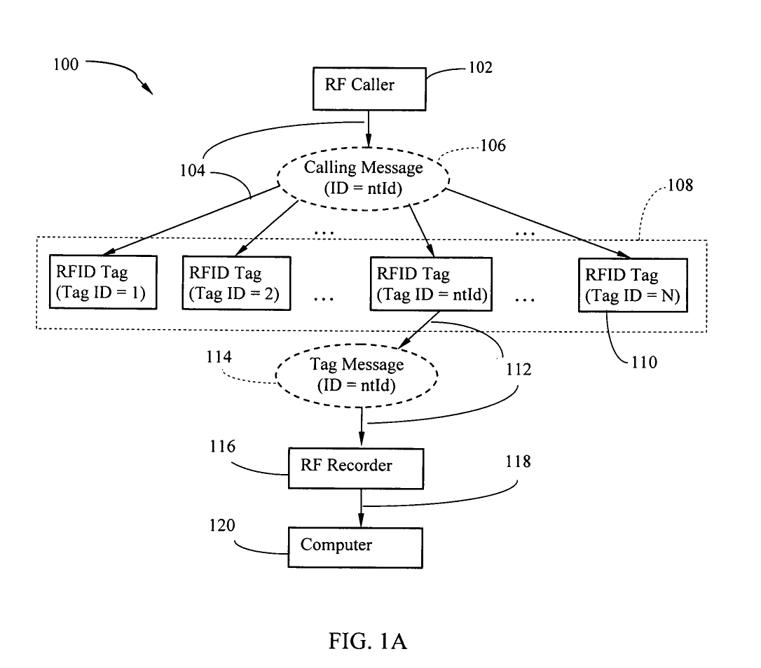

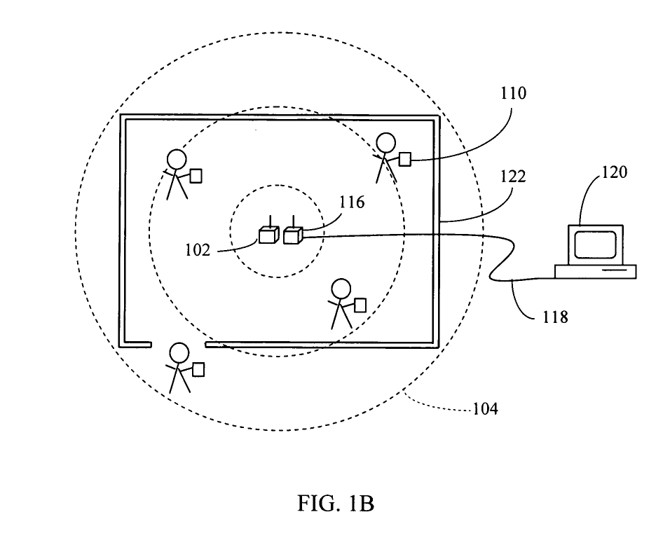

One embodiment of anti-collision method and system for reading data from multiple RFID tags is an attendance recording system illustrated in FIG. 1A and FIG. 1B.

Referring to FIG. 1A and FIG. 1B, attendance recording system 100 includes a RF caller 102, a plurality of RFID tags 108, a RF recorder 116 and a computer 120. Each RFID tag 110 of RFID tags 108 is assigned with a unique identifier (tag ID) and attached to an object, which attendance needs to be recorded. Attendance recording system 100 records RFID tag 110 appearance around an attendance recording area 122.

RF caller 102 transmits a calling message 106 through RF calling channel 104, each calling message 106 includes a particular tag ID, which belongs to a RFID tag 110 of RFID tags 108; RF caller 102 iterates to put in calling message 106 with all predefined tag IDs. The RF signal of calling message 106 that RFID caller 102 transmits can cover the attendance recording area 122.

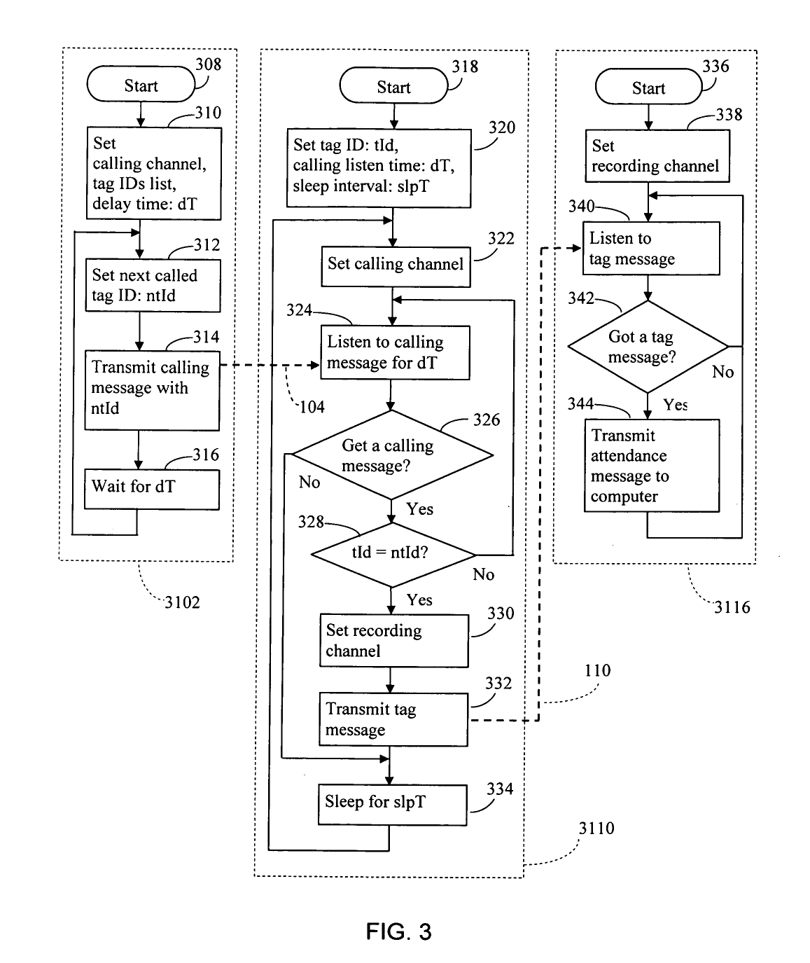

RF caller 102 executes caller software with program flow 3102 in FIG. 3:

RF caller 102 starts its program with step 308 when it is powered on.

In step 310, parameters and status will be initialized, which includes setting RF calling channel 104, predefined RFID tag IDs list and a delay time to control the cycle of transmitting calling message 106.

In step 312, one of the predefined RFID tag IDs is assigned to next calling message 106.

In step 314, a calling message 106 with a tag ID is transmitted through calling channel 104.

In step 316, program waits for a predefine time, and then goes to step 312.

RFID tags 108 listen to the calling message 106 on the RF calling channel 104 periodically. When a RFID tag 110 has received the calling message 106, this RFID tag 110 will check the tag ID in the calling message 106, if the tag ID is same as the tag ID of this RFID tag 110 itself, this RFID tag 110 will transmit a tag message 114, which contains RFID tag 110 related data, through the recording channel 112.

Each RFID tag 110 of RFID tags 108 executes tag software with program flow 3110 in FIG. 3:

A RFID tag 110 starts its program with step 318 when it is powered on.

In step 320, parameters will be initialized, which include tag ID, calling listen time to control the duration of listening to the calling message 106 and sleep interval to control the cycle of listening to the calling message 106.

In step 322, the calling channel 104 is set up.

In step 324, RFID tag 110 listens to the calling message 106 on the RF calling channel 104 for a predefined time.

In step 326, if a calling message 106 is received, program goes to step 328, otherwise it goes to step 334.

In step 328, if the tag ID of this RFID tag 110 equals to the tag ID contained in the received calling message 106, program goes to step 330, otherwise it goes to step 324.

In step 330, recording channel 112 is set up.

In step 332, tag message 114 is transmitted through recording channel 112.

In step 334, program sleeps for a predefined time, and then goes to step 322.

RF Recorder 116 keeps on listening to a tag message 114 on RF recording channel 112.

If the RF Recorder 116 has received a tag message 114, it will transmit an attendance message to computer 120 through communication connection 118 for recording.

RF Recorder 116 executes recorder software with program flow 3116 in FIG. 3:

RF Recorder 116 starts its program with step 338 when it is powered on.

In step 338, recording channel 112 is set up.

In step 340, RF Recorder 116 listens to the tag message 114 on the recording channel 112.

In step 342, if a tag message 114 is received, program goes to step 344, otherwise it goes to step 340.

In step 344, an attendance message is sent to computer 120 through communication connection 118.

Computer 120 receives the attendance message through communication connection 118 and records it.

The result of the system operating as above description is: every time only one calling message 106 is transmitted through the calling channel 104, accordingly at most one tag message 114 is transmitted through the recording channel 112, then not any RF signal collision will happen.

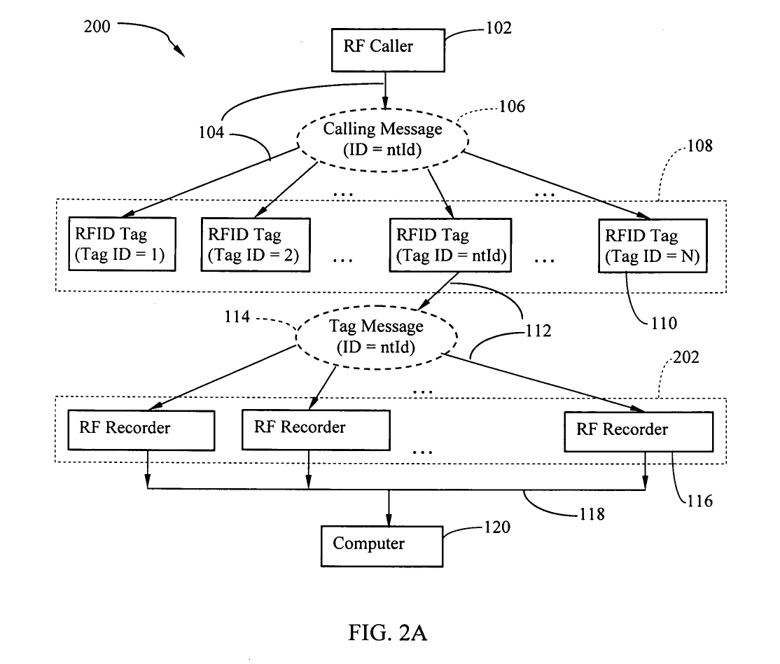

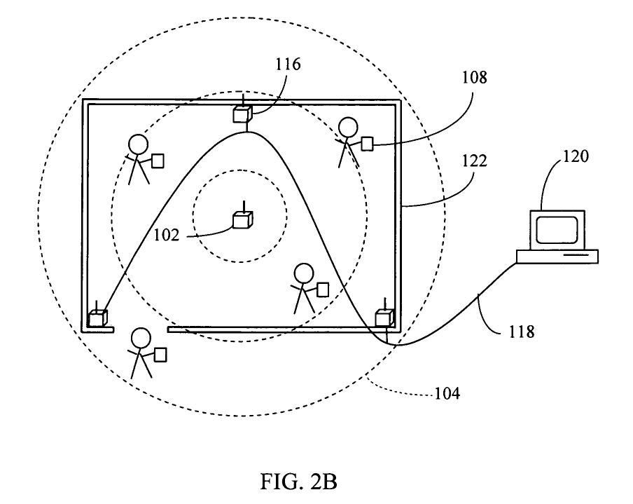

Referring now to FIG. 2A and FIG. 2B, a second embodiment is similar to the first embodiment in FIG. 1A and FIG. 1B, except there is a plurality of RF recorders 202 in the second embodiment. In second embodiment 200, the RF caller 102, RF recorder 116, and RFID tag 110 also execute the program flows illustrated in FIG. 3.

The advantage of the second embodiment is when the attendance recording area 122 is too large, more than one RF recorder 116 within the system can reduce the possibility of missing to receive a tag message 114 by RF recorder 116. Normally the RF signal strength transmitted by a RFID tag 110 is lower than by RF caller 102, it is possible a RFID tag 110 can receive a calling message from RF caller 102, but a RF recorder 116 misses to receive a tag message 114 from a RFID tag 110.

One option in second embodiment 200 is that each RF recorder 116 can be assigned a unique recorder identifier, when a RF recorder 116 transmits an attendance message to computer 120, its recorder identifier can be included in the attendance message.

What is claimed is:

1. A radio frequency identification system, comprising:
a radio frequency (RF) caller for transmitting a calling message periodically through a RF calling channel;
a plurality of radio frequency identifier (RFID) tags for listening the calling message on the RF calling channel, each responding the calling message by transmitting a tag message through a RF recording channel; and
a RF recorder for receiving the tag message on the RF recording channel.

2. The system of claim 1, wherein each tag of said RFID tags is assigned with a unique identifier (tag ID).

3. The system of claim 2, wherein said RF caller maintains a tag IDs list of said RFID tags.

4. The system of claim 2, wherein said calling message contains a tag ID of one of said RFID tags.

5. The system of claim 4, wherein one of said RFID tags, which has the same tag ID as that contained in the calling message, is capable of transmitting a tag message through the RF recording channel.

6. A radio frequency identification system, comprising:
a radio frequency (RF) caller for transmitting a calling message through a RF calling channel;
a plurality of radio frequency identifier (RFID) tags for listening the calling message on the RF calling channel, each responding the calling message by transmitting a tag message through a RF recording channel; and
a plurality of radio frequency (RF) recorders for receiving the tag message on the RF recording channel.

7. A method of avoiding RF signal collision for reading data from multiple RFID tags, comprising the steps of:
(a) providing a plurality of RFID tags, each tag being assigned with an unique identifier number (tag ID);
(b) transmitting a calling message periodically from a radio frequency (RF) caller through a RF calling channel to the RFID tags, the calling message containing an tag ID of one of said RFID tags; and
(c) transmitting a tag message from the RFID tag having a tag ID that is the same as the tag ID in the calling message through a recording channel to a RF recorder.
